(19) United States
(12) Patent Application Publication
(10) Pub. No.: US 2013/0059028 A1
(43) Pub. Date: Mar. 7, 2013

(54) Compositions and Methods for Providing a Life-Stage-Appropriate Animal Diet

(71) Applicants: Julie Marie Foy, Mason, OH (US); Rebecca Massie Grey, West Alexandria, OH (US); Thomas Wendell Reed, Deerfield, OH (US); Leslie Rolce Myrie, JR., Deerfield, OH (US); Benito Alberto Romanachi, Mason, OH (US); Katherine P. Boebel, West Alexandria, OH (US); Kristen M. Carnagey, Mason, OH (US); Roxanne Drago Westendorf, Colerain Township, OH (US)

(72) Inventors: Julie Marie Foy, Mason, OH (US); Rebecca Massie Grey, West Alexandria, OH (US); Thomas Wendell Reed, Deerfield, OH (US); Leslie Rolce Myrie, JR., Deerfield, OH (US); Benito Alberto Romanachi, Mason, OH (US); Katherine P. Boebel, West Alexandria, OH (US); Kristen M. Carnagey, Mason, OH (US); Roxanne Drago Westendorf, Colerain Township, OH (US)

(21) Appl. No.: 13/223,943

(22) Filed: Sep. 1, 2011

(51) Int. Cl. A23K 1/18; A23L 1/30; A23L 1/302; A23L 1/304; A23L 1/00; A23L 1/303

(52) U.S. Cl. 426/2; 426/87; 426/73; 426/72; 426/74; 426/61

(57) ABSTRACT

An array of animal diets nutritionally tailored to different animal life stages. A method for facilitating the selection of a life-stage appropriate diet for an animal. The method may comprise providing an indicium to facilitate an anthropomorphic connection between the animal life stage and a corresponding human life stage.

### FIELD OF THE INVENTION

The invention relates generally to compositions and methods for providing a life-stage-appropriate animal diet.

### BACKGROUND OF THE INVENTION

It has been recognized in many species of animals that dietary needs change over an animal's life span in predictable ways. The most obvious of these may be the needs of nursing animals as opposed to weaned animals. However, many aspects of an animal's ideal diet may change over time after weaning. As examples, caloric requirements, or the desired ratio of different caloric sources (such as fats and proteins), or the caloric density of a diet may change as an animal progresses from adolescence to maturity. Recently, it has been recognized that many animals have different dietary needs at different stages of maturity. Beyond apparent, special needs, such as needs arising from illness or physical deficits (such as missing teeth), an animal's diet may desirably include different nutrients or different amounts of nutrients as the animal ages. Specialized diets may help to encourage healthy growth, maintain healthy weight, and prevent or delay physical and/or mental, age-related decline.

Prior attempts to market companion animal diets, such as dog and cat foods, for a “Senior” life stage have had limited success. Caretakers for companion animals may be reluctant to purchase a diet for a life-stage that suggests an animal is in decline or nearing the end of its lifespan. In some instances, this reluctance may be tied to a desire to deny the approaching end of the animal's life. In other instances, the reluctance to purchase a diet in a late life-stage may be due to cognitive dissonance between the concept that a companion animal is old and the animal's activity level or general health. That is, it may be easier to purchase a “Senior” diet for an animal who is inactive or ill than it is to purchase the same diet for an animal of the same age who remains active and in generally good health. However, improper diet selection may exacerbate existing health problems, or deny an animal the potential benefits of a diet that could prevent, mitigate, or even reverse undesirable signs of aging.

There remains a need for a diet that addresses the different life-stages of animals, such as dogs or cats. There remains a need for a system that facilitates the selection of a life-stage-appropriate diet for an animal.

### SUMMARY OF THE INVENTION

In some aspects, the present disclosure relates to an array of animal diets. The array may comprise a first diet. The first diet may comprise a first level of a nutrient. The first level of the nutrient may be suitable for a first animal life stage. The first diet may be disposed in a first package. The array may comprise a second diet. The second diet may comprise a second level of the nutrient. The second level of the nutrient may be suitable for a second animal life stage. The second diet may be disposed in a second package. The array may comprise a third diet. The third diet may comprise a third level of the nutrient. The third level of the nutrient may be suitable for a third animal life stage. The third diet may be disposed in a third package. Each of the first, second, and third packages may comprise an indicium. The indicium of the first package may comprise an image of a human being in a life stage comparable to the first animal life stage. The indicium of the second package may comprise an image of a human being in a life stage comparable to the second animal life stage. The indicium of the third package may comprise an image of a human being in a life stage comparable to the third animal life stage.

The indicia may be selected from the group consisting of icons, drawings, and photographs. The indicium of the first package may comprise the human being and an animal engaged in an activity characteristic of the first animal life stage. The nutrient may be selected from the group consisting of l-carnitine, low- or moderately-fermentable fiber, total fiber content, total protein content, vitamin E, other antioxidants, vitamin A, beta-carotene, lutein, taurine, fatty acids, the ratio of omega-3 to omega-6 fatty acids, glucosamine, chondroitin sulphate, DHA, EPA, caloric density, calcium, phosphorous, magnesium, lysine, sodium hexametaphosphates, a calorie restriction mimetic (such as mannoheptulose), a probiotic, a prebiotic, and combinations thereof. The nutrient may be selected from the group consisting of l-carnitine, low- or moderately-fermentable fiber, total fiber content, total protein content, vitamin E, other antioxidants, vitamin A, beta-carotene, lutein, taurine, fatty acids, the ratio of omega-3 to omega-6 fatty acids, glucosamine, chondroitin sulphate, DHA, EPA, caloric density, calcium, phosphorous, magnesium, lysine, sodium hexametaphosphates, a calorie restriction mimetic (such as mannoheptulose, a probiotic, a prebiotic, sodium bisulfate, and combinations thereof.

Each of the first, second, and third diets may comprise a second nutrient at a first, second, and third level, respectively. Each of the first, second, and third diets may comprise a third nutrient at a first, second, and third level, respectively. The array may comprise a fourth diet. The fourth diet may comprise a fourth level of the nutrient. The fourth level of the nutrient may be suitable for a fourth animal life stage. The fourth diet may be disposed in a fourth package. The fourth package may comprise an indicium. The indicium of the fourth package may comprise an image of a human being in a life stage comparable to the fourth animal stage of life.

At least one of the first, second, third, and fourth levels of a nutrient may be zero. Each of the first, second, third, and fourth diets may comprise a second nutrient at a first, second, third, and fourth level, respectively. Each of the first, second, third, and fourth diets may comprise a third nutrient at a first, second, third, and fourth level, respectively. The human being of the indicium of the first package, the indicium of the second package, and the indicium of the third package, may be the same human being.

In some aspects, the present disclosure relates to a method for facilitating the selection of a life-stage appropriate diet for an animal. The method may comprise providing an array of diets for an animal. The diets may be nutritionally tailored to at least three life stages of the animal. Each of the diets may be disposed in a package. The method may comprise associating each package with an indicium. The indicium may comprise an image of a human being. The human being may be in a life stage comparable to the life stage of the animal for which the diet inside the package is nutritionally tailored. The indicia may comprise an image of an animal in a life stage comparable to the life stage of the animal for which the diet inside the package is nutritionally tailored. The indicia may comprise an image of the human being interacting with the animal in a manner characteristic of the life stage of the animal for which the diet inside the package is nutritionally tailored.

The array may comprise at least four distinct diets. The array may comprise at least six distinct diets. The animal may be a dog or a cat. The human being of each indicium may be the same human being. The animal of each indicium may be the same animal.

### BRIEF DESCRIPTION OF THE DRAWINGS

FIG. 1 is an exemplary indicium comprising an image of a dog.

FIG. 2 is an exemplary indicium comprising an image of a cat.

### DETAILED DESCRIPTION OF THE INVENTION

When presented with an array of animal diets for animals of different life stages, consumers may have a difficult time selecting the appropriate diet for a specific animal. This difficulty may be unrelated to the text labeling on the package. For example, a consumer may have no problem reading words such as “Puppy,” “Adult,” “Mature,” and “Senior,” on different bags, or even reading corresponding information, such as age charts, but may still have difficulty in choosing an appropriate product. As a more specific example, a consumer may be unmotivated to purchase “Mature” or “Senior” food for a mature or senior dog not because of a lack of comprehension of the text, but because the name given to a life stage does not seem appropriate, or because an animal seems younger or healthier than a representative animal of the same species and age. This problem may be exacerbated because dietary changes may be most helpful in preventing age-related deterioration, rather than trying to “undo” problems after they arise. That is, a life stage may correspond with dietary needs that are not visible even to a concerned, attentive caregiver. Accordingly, the selection of an appropriate diet may be difficult even with textual tools for selecting a product from an array of diets.

In some aspects, the present disclosure relates to an array of diets suitable for animals of a given species at different ages or stages of maturity. In some aspects, the present disclosure relates to an array of diets and a method for facilitating the selection of an age-appropriate diet for an animal. In some studies, increasing the number of diets in the array from two or three diets to three or four diets and providing contextual information about animal life stages, may double—or more than double—the number of caregivers who select a life-stage appropriate diet for a given animal.

As used herein “nutrient” refers to any desired dietary substance, including, without limitation, vitamins, minerals, proteins, amino acids, fatty acids, fats, carbohydrates, fiber and fiber-sources, starches, co-vitamins, drugs or medications, and the like. “Nutrient” may, where so described, refer to a particular ratio of substances, such as, for example, the ratio of omega-6 fatty acids to omega-3 fatty acids, or the ratio of insoluble fiber to soluble fiber. As used herein, “nutrient” does not extend to palatants, flavorings, colorants, or other additives which may be used to differentiate animal diets with no significant change in the nutritional value of the diets.

As discussed above, nutrition requirements may change significantly as an animal matures. Different levels of various nutrients, or different nutrients altogether, may be required at different life stages. As used herein, “life stage” or “stage” refers to an approximate span of years generally associated with a particular phase of growth, stasis, or decline for a particular species. Although any individual animal within the specified years of age may exhibit none or fewer than all of the typical characteristics of a given life stage, the life stage overall is a description of a typical experience for most animals of the same species and/or breed.

Dogs, for example may have a puppy life stage generally associated with dogs 0 to 1.25 years of age for small breeds (average less than 20 pounds or about 9.1 kg when full grown) and dogs 0-2 years of age for large breeds (average greater than 50 pounds or about 23 kg when full grown). Dogs may have an adult life stage generally associated with dogs 2 to 7 years of age, and a mature life stage generally associated with dogs 7 years of age or older. A fourth life stage may also be identified, referred to herein as “Senior”, and referring to dogs 11 years of age or older (9 years or older for large breeds). When a fourth life stage is introduced, the mature life stage may refer to dogs 7 to 11 years of age. It should be understood that these age ranges are exemplary and may vary. In particular, the age ranges for each life stage may vary if a diet is directed to a specific size or breed of dog. For example, small and large dogs may age differently, and thus may progress through different life stages at different absolute ages. Further, depending on the specific nutrients varied in the diet, the age range associated with a particular life stage may vary, as some nutrients may be needed at different or overlapping phases relative to the life stage age ranges described herein.

By way of more particular examples, the following table shows how life stages might be adjusted for dogs of different sizes and/or breeds. It should be understood that an age or weight of 0 (zero) refers to a dog so young or so light that its age and/or weight rounds to zero, and is not meant to encompass “dogs” that do not exist (i.e., “dogs” of actual zero age and/or actual zero mass).

TABLE 1
Exemplary Age Ranges (in years) for Life Stages
for Dogs of Different Sizes

| | Size | | | |
|---|---|---|---|---|
| | | | | Giant |
| | Small | Medium | Large | Over |
| Stage | 0 to 20 pounds | 21-50 pounds | 51-100 pounds | 90 pounds |
| Puppy | 0-1 | 0-1 | 0-1.5 | 0-2 |
| Adult | 1-7 | 1-7 | 1.5-6 | 2-5 |
| Mature | 7+ (7-11) | 7+ (7-10) | 6+ (6-8) | 5+ (5-7) |
| (Mature, if | | | | |
| a Senior | | | | |
| life stage | | | | |
| is also | | | | |
| defined) | | | | |
| Senior | 11+ | 10+ | 8+ | 7+ |

Cats, as another example, may have slightly different life stages, with a kitten (or pediatric) stage generally associated with cats 0 to 1 year of age; and an adult stage generally associated with cats 1 to 7 years of age. Cats may have a mature stage generally associated with cats 7 years of age or greater. A fourth life stage may also be identified, referred to herein as “Senior”, and referring to cats 11 years of age or older. When a fourth life stage is introduced, the mature life stage may refer to cats 7 to 11 years of age. As with dogs, cat life stages may correspond to different age ranges under some circumstances. For example, certain breeds of cats may exhibit different life stage progression patterns, or some specific nutrients may be needed at different or overlapping phases relative to the life stage age ranges described herein.

These life stages may go by different names, such as pediatric, maintenance, geriatric, growth, etc., but these fundamental age divisions are believed to represent key inflection points in an animal's dietary needs. Dietary needs may change because of the nature of the nutrients required. For example, diets for a puppy/kitten life stage may have a relatively high concentration of fat content and caloric density to support rapid growth, including rapid neuron development. Diets for an adult phase may have relatively lower fat content and caloric density, relative to a puppy/kitten diet, and diets for a mature phase may have still lower fat content and caloric density. In contrast, a diet for a senior phase may have similar or slightly higher fat content and greater caloric density than a diet for mature phase, to provide sufficient caloric intake for weight maintenance accounting for appetite, which typically decreases with advanced age. Senior diets may comprise relatively high amounts of vitamin E, to support immune function, as well as other antioxidants, to support general cellular response to environmental stressors (including UV exposure, toxin accumulation, etc.) that build over time. Diets throughout the array may include probiotics or prebiotics, with different strains or quantities available in different diets.

Entirely different nutrients may be included in some life stage diets and excluded from other life stage diets. For example, puppy/kitten and/or adult stage diets may include DHA (docosahexaenoic acid) and/or EPA (eicosapentaenoic acid), which are fatty acids associated with healthy neuron growth and development. Adult and/or mature diets may comprise less DHA and/or EPA. For example, adult and mature may not have any supplemental DHA and/or EPA (e.g., any DHA or EPA added apart from what is included in the ingredients in the food, such as meat, grains, vegetables, and the like). In some arrays, a senior diet may have relatively higher DHA and/or EPA content than an adult or mature diet, to help maintain cognitive function with advancing age. In some arrays, adult, mature, and/or senior diets may comprise l-carnitine for healthy weight maintenance, whereas a puppy diet may have no l-carnitine. Similarly, in some arrays, adult, mature, and/or senior diets may comprise glucosamine and/or chondroitin sulphate for joint and cartilage support (respectively), whereas a puppy diet may have no glucosamine and/or chondroitin sulphate. Mature and/or senior diets may include nutrients or other additives intended to support cognitive maintenance, joint maintenance, dental health, skin lubrication, hair maintenance and/or luster, digestive health, and the like, which may be different from the nutrients needed for healthy development.

Over the four life stages, some nutrients may be increased progressively from puppy/kitten to adult to mature to senior. For example, the percentage of total fiber content that comes from low or moderately-fermentable fibers, such as beet pulp or fructooligosaccharides (FOS) may increase progressively along three or four life stage diets. Fiber fermentability may be assessed in vitro as described, for example, in Sunvold, et al., Dietary fiber for Dogs: IV. In vitro fermentation of selected fiber sources by dog fecal inoculums and in vivo digestion and metabolism of fiber-supplemented diets, J ANIM SCI 1995, 73:1099-1109. As used herein, low or moderately-fermentable fibers are those that show a total SCFA (short chain fatty acid) production after 24 hours of less than or equal to 5 mmol/g of organic matter. In some embodiments, the ratio of insoluble fiber to soluble fiber in the diet may be higher at one or more later life stages, relative to one or more earlier life stages.

Of course, the nutritional benefits of a diet tailored to a specific life stage can only be realized when a life-stage appropriate diet is provided to an animal. Feeding a puppy low-calorie weight maintenance diet intended for a later life stage might not be as beneficial as feeding a puppy a calorie-dense puppy diet. Similarly, feeding a mature dog a high-calorie puppy diet may exacerbate weight maintenance problems, which may in turn exacerbate other signs of aging, such as reduced mobility or increased joint pain. When choosing a diet, however, an animal's caregiver may be influenced by perceptions that negatively impact the caregiver's ability to select an appropriate diet. It has been found that these perceptions can be overcome for a large number of caregivers by presenting an array of life-stage diets with “humanizing” context. That is, caregivers respond favorably to the observation that humans eat differently at different life stages, without regard to illness or incapacity. That is, healthy, active “seniors” may eat differently than children, even though they are healthy and living full, vibrant lives. The exact mechanism is not fully understood, but this anthropomorphic connection between human caregivers and the animal may help overcome an initial—erroneous—perception that mature or senior diets are for dogs in noticeable decline, e.g., that are noticeably sickly or decrepit.

Some caregivers will select an animal diet from a store shelf without the benefit of consultation with a nutritionist or veterinarian, or even an extended textual explanation which may provide a helpful anthropomorphic connection. Accordingly, an array of diets tailored to different life stages may be provided with indicia to help humanize the animal life stages and facilitate selection of an age-appropriate diet. In some embodiments, the array comprises first, second, and third diets. In some embodiments, the array comprises a fourth diet. The first, second, third, and, if present, fourth diets may each be tailored to a specific animal life stage, at least with regard to the level of a certain nutrient. The first, second, third, and, if present, fourth diet may comprise profiles of two, three, or more nutrients, each of the profiles tailored to changing dietary needs over the three or four life stages. In some embodiments, five or six life-stage appropriate diets are presented. The additional life stages may reflect further sub-divisions of the puppy life stage, reflecting a growth curve during the first and/or second years of life, with somewhat different caloric density and nutrient requirements during each sub-division of the puppy life stage.

Each of the first, second, and third diets may comprise first, second, and third levels, respectively, of a given nutrient, each of the levels suitable for a first, second, and third animal life stage, respectively. The given nutrient may be selected, for example, from l-carnitine, low- or moderately-fermentable fiber, total fiber content, total protein content, vitamin E, vitamin C, other antioxidants, vitamin A, beta-carotene, lutein, taurine, fatty acids, the ratio of omega-6 to omega-3 fatty acids, glucosamine, chondroitin sulphate, DHA, EPA, caloric density, calcium, phosphorous, magnesium, lysine, sodium hexametaphosphates, a calorie restriction mimetic (such as mannoheptulose), anti-inflammatory compounds, a probiotic, a prebiotic, sodium bisulfate, low glycemic index starches, high glycemic index starches, or combinations thereof. The first, second, and third levels (and fourth, fifth, and sixth levels, if fourth, fifth, and sixth diets are present in the array) may each be different, or two or more levels may be the same, but at least one of the levels is different within the array. Table 2 provides more detailed, exemplary embodiments showing how certain nutrients might vary in an array of diets nutritionally tailored to different animal life stages. It should be understood that any single nutrient or any combination of nutrients shown in Table 2 might be present in a specific array of diets.

TABLE 2
Exemplary Nutrient Profiles for Dog Diets in Three or Four Life Stages

| | Mature | Index Versus Mature Life Stage (%) | | | |
|---|---|---|---|---|---|
| Nutrient | Absolute | Puppy | Adult | Mature | Senior |
| ME kcal/kg | 3300-3700 | 110-130 | 102-115 | 100 | 102-110 |
| diet - Med | | | | | |
| through | | | | | |
| Giant Breed | | | | | |
| ME kcal/kg | 3600-3800 | 110-115 | 105-110 | 100 | 100-110 |
| diet - | | | | | |
| Small Breeds | | | | | |
| Protein g/ | 70-80 | 104-110 | 90-98 | 100 | 102-110 |
| 1000 kcal ME | | | | | |
| DHA | 0.01-0.10 | 200-2000, | 50-90 | 100 | 200-2000, |
| (mg/100 g diet) | | or | | | or |
| | | 500-1800 | | | 500-1800 |
| Vitamin E | 280-500 | 20-70 | 20-70 | 100 | 100-200 |
| (IU/kg) | | | | | |
| Supplemental | 50-100 | 0-50 | 0-100, | 100 | 100-200 |
| L-carnitine | | | or 0-70 | | |
| (mg/kg diet) | | | | | |
| Beta-carotene | 20-40 | 1-20 | 1-20 | 100 | 100-150 |
| (mg/kg diet) | | | | | |
| Crude Fiber, % | 2.0-3.0 | 50-80 | 60-90 | 100 | 90-140 |
| Beet Pulp (%) | 2.5-4.0 | 70-90 | 60-90 | 100 | 110-150 |

TABLE 3
Exemplary Nutrient Profiles for Cat Diets in Three or Four Life Stages

| | Mature | Adult | Index Versus Mature Life Stage (%) | | | |
|---|---|---|---|---|---|---|
| | Absolute | Absolute | Kitten | Adult | Mature | Senior |
| ME kcal/kg diet | 3500-3900 | — | 103-115 | 100-105 | 100 | 105-115 |
| Protein g/1000 kcal ME | 90-95 | — | 90-100 | 95-100 | 100 | 90-105, or 90-99 |
| Lysine g/1000 kcal ME | 5-6 | — | 90-99 | 95-100 | 100 | 105-135 |
| DHA (mg/100 g diet) | 0.06-0.16 | — | 170-200 | 50-90 | 100 | 150-250 |
| Vitamin E (IU/kg) | 475-550 | — | 35-60 | 35-60 | 100 | 100-200 |
| Supplemental L- | 50 | — | 0-50 | 0-100, or 0-70 | 100 | 100-200 |
| carnitine (mg/kg diet) | | | | | | |
| Crude Fiber, % | 1.5-1.8 | — | 100-115 | 100-115 | 100 | 105-130 |
| Beet Pulp (%) | 2.5-3.0 | — | 100-120 | 100-120 | 100 | 130-160 |
| Sodium Bisulfate (in | 0 | 0.8 | 0 | 100 | 0 | 0 |
| percent relative to | | | | | | |
| Adult) | | | | | | |

Each of the first, second, and third diets may be disposed in a first, second, and third package, respectively. Each of the first, second, and third packages may comprise an indicium. Each indicium may comprise an image of a human being. The human being may be in a life stage comparable to the animal life stage of the diet inside the package. Based on the life stages provided above, exemplary human life stages, in years of age, may be as presented Tables 4 and 5.

TABLE 4
Exemplary Correspondence between Animal and
Human Life Stages for Dogs (all ages in years)

| | Stage and age | | | |
|---|---|---|---|---|
| Corresponding | Puppy | Adult | Mature | Senior |
| Human age | 0-1 (S/M)/0-2 (L) | 2-7 | 7-11 | 11+ |
| Analogous | 0-15 | 15-44 | 44-60 | 60+ |
| human age | | | | |
| range | | | | |
| (Small/Medium | | | | |
| Dog) | | | | |
| Analogous | 0-24 | 24-50 | 50-61 | 61+ |
| human age | | | | |
| range (Large | | | | |
| Dog) | | | | |
| Exemplary | 5 | 30 | 50 | 70 |
| human age | | | | |

TABLE 5
Exemplary Correspondence between Animal and
Human Life Stages for Cats (all ages in years)

| | Stage and cat age: | | | |
|---|---|---|---|---|
| | Kitten | Adult | Mature | Senior |
| | 0-1 | 1-7 | 7-11 | 11+ |
| Analogous | 0-15 | 15-44 | 44-60 | 60+ |
| human age | | | | |
| range | | | | |
| Exemplary | 5 | 30 | 50 | 70 |
| human age | | | | |

The image of the human may help to draw an anthropomorphic connection between human aging, human diet, animal aging, and animal diet. For example, the image of the human may include the human engaged in activities stereotypically associated with the human life stage analogous to the animal life stage for which a given diet in the array is nutritionally tailored. The human activity may include eating an age-appropriate food. Some exemplary Human characteristics and/or activities are presented in Table 6.

TABLE 6
Exemplary Human and Animal Characteristics in Various Life Stages

| | Human | | Dog | Cat |
|---|---|---|---|---|
| Human age | characteristics | Human Food | characteristics | characteristics |
| 5 | Small build, | Milk | Playful, energy, | Playful, energy, |
| (Puppy/ | playful, pigtails, | Fruit | dog may be in | cat may be in |
| Kitten) | “baby” fat, playing | CHEERIOS ™ | motion, walking, | motion, |
| | on swing set or | cereal | tumbling, curious | walking, |
| | playground, playing | | expression | tumbling, |
| | with toys | | | curious |
| | | | | expression |
| 30 | Recreational athlete | Sports drink bottle | Lean, working, | Lean, active, |
| (Adult) | build/fit | Performance | active, walking | standing in a |
| | Professional, hard | nutrition bar (e.g., | briskly or running | windowsill or |
| | working | exercise recovery | | perched in a |
| | | supplement) | | relatively high |
| | | | | spot that would |
| | | | | require jumping |
| | | | | or climbing to |
| | | | | reach, alert (ear |
| | | | | posture |
| | | | | showing |
| | | | | awareness, |
| | | | | looking out |
| | | | | window or over |
| | | | | perch); |
| | | | | pouncing or |
| | | | | stalking |
| 50 | Graying hair, | Water | Routine tasks like | Healthy but |
| (Mature) | glasses, reduced | Nutritious snack | getting paper, | heavier than |
| | activity | bar (e.g., granola) | slippers; standing | adult cat, sitting |
| | Wrinkles | Diet soda | with wagging or | or perched in |
| | | Low calorie foods | lifted tail | somewhat |
| | | and/or small | | lower spot or in |
| | | portions | | posture |
| | | | | showing |
| | | | | rest/lower alert; |
| | | | | standing with |
| | | | | raised or |
| | | | | moving tail |
| 70 | Gray, thinner | Protein shake or | Content, slow | Being held, |
| (Senior) | Wrinkled | drink (such as | stroll, with the | visible stairs or |
| | | ENSURE ™ | family on the | other aids to get |
| | | nutrition | couch (e.g., he | to bed or |
| | | beverages) | can still climb), | furniture, restful |
| | | Protein bar | soothing location | posture, may be |
| | | | but not ready to | seated or |
| | | | “retire”, may be | reclining |
| | | | seated or reclining | |

The indicium may include an image of an animal. The life stage of the animal depicted in the indicium may correspond to the life stage of the animal for which the diet inside the package is nutritionally tailored. The image may include an image of a human engaged in an activity with an animal that is appropriate for the life stage of the animal. Some examples of life-stage appropriate activities are included in the table above. The images may convey healthy activities for humans and animals of different life stages. The human in the images may be presented as the same person throughout the array. That is, the human image in the various indicia may be styled to look like the same individual human at different life stages. The human in the images may be presented as different individual humans. Similarly, the animal may be the same or different (e.g., same or different breed, size, color, etc.) at different life stages.

The image of the human and/or animal may be of any suitable form and style. For example, the image may be a photograph of an actual human being (or animal), or a modified photograph, or a line drawing, painting, silhouette, cartoon, icon, graphic illustration, or the like. The model human (and/or animal) for the image may be real or imaginary. The impression created by the image may be realistic (as with an unaltered photograph) or impressionistic, detailed or simple, but the images, taken across the array, should communicate a change in the life stage of the human (and/or animal) on each package associated with a different animal life stage (the array could include multiple diets suitable for a single life stage, as well as different diets for different life stages).

The image of the human and/or animal may be aspirational. That is, the image may show the human and/or animal embodying the desired benefits of the diet with which the image is associated. For example, if a diet is designed, nutritionally, to support healthy hair and skin, the human and/or animal may visibly display full, lustrous hair and unblemished skin (to the degree the animal's skin is observable). As another example, if a diet is designed, nutritionally, to support healthy weight maintenance, the human and/or animal may visibly display a healthy weight. For example, the human may be depicted such that his or her weight can be observed or inferred, as by silhouette, and not in loose clothing or in postures which might make it difficult to observe or infer the human's weight.

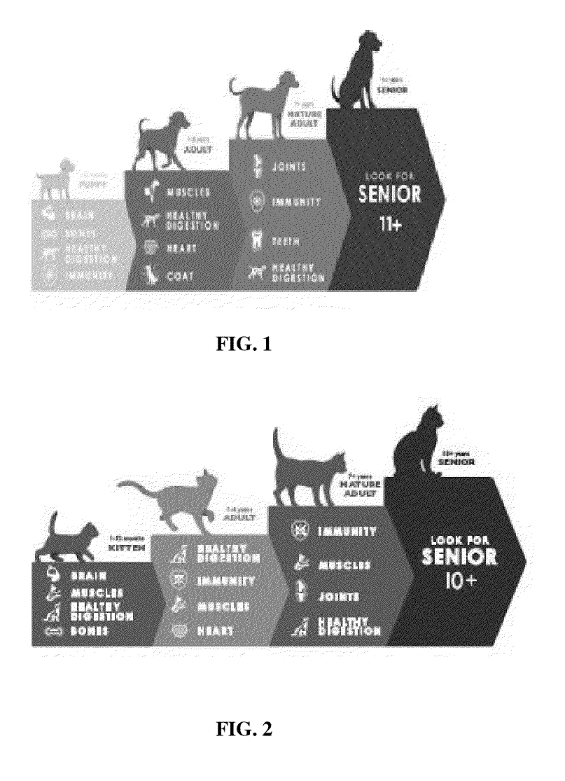

In one particular embodiment, the image of the animal is like those in FIG. 1. FIG. 1 shows a set of stairs of progressively greater height. Each stair represents a diet in an array of animal diets. Each stair is associated with a specific life stage. At the top of each stair is a silhouette or simplified image of a dog. As shown in FIG. 1, words and numbers are used to describe each life stage, however in some embodiments, only the image of the dog is used. Each stair may comprise one or more descriptors of the benefits or ingredients that differ in different life stage diets, and/or comprise one or more descriptors of the physiological or anatomical benefits which may accrue to an animal fed that specific life stage diet. In some embodiments, only the animal image and/or descriptors for a single stage are legible or easily visible. The other animal images and/or descriptors (but not the other stairs) may be absent or de-emphasized. For example, a single stair and/or animal image may be in color, while the other stairs and/or images are in black-and-white or grayscale, or a single stair and/or animal image may be in high resolution, while the other stairs and/or animal images are blurred or otherwise obscured. In some embodiments, the indicium of FIG. 1 provides an indication of all of the diets available in the array and an indication of which diet is contained in the package on which the indicium is disposed. FIG. 2 provides a similar image for an array of cat diets, which can be similarly modified as desired. Both FIG. 1 and FIG. 2 show the four stairs of varying colors, however, the number of stairs and the colors could be varied as desired. Of course, either image could be modified to reflect diets for other animals, such as, without limitation, ferrets, guinea pigs, rabbits, hamsters, mice, birds, reptiles, fish, primates, and the like.

The package itself may be a bag, box, jar, crate, can, pouch, or any suitable package. The package may contain the diet and prevent it from dispersing or leaking during transportation and storage (as if the diet is provided in bite-sized kibble or other relatively small, easily dispersed particles or aliquots, or in a wet form). The package may reduce or prevent the movement of moisture, air, or other substances between the inside and the outside of the package, as to reduce the likelihood that the diet inside the package will become stale, too dry, too moist, or contaminated during transportation and storage. The package may be resealable.

An array of diets, each of the diets nutritionally tailored to an animal life stage and disposed in a package, each package comprising an image of a human being in a life stage comparable to the animal life stage for which the diet is diet is tailored, may facilitate proper selection of age-appropriate animal diet. Such images may facilitate an anthropomorphic connection that allows a caregiver to understand age-related dietary needs in animals in a more personal, intuitive manner, and/or may help overcome an erroneous perception that mature or senior formulas are inappropriate for healthy, active, happy animals.

In some aspects, this disclosure relates to a method for facilitating the selection of a life-stage appropriate diet for an animal. The method may comprise providing an array of diets for an animal. The diets may be nutritionally tailored to a life stage of the animal. For example, as described above, one or more nutrients may be varied in level, proportion, or presence in different diets in the array, to account for changing nutritional needs in different life stages. The method may comprise associating each package in the array with an indicum. In this context, “associating” may be tangible or intangible, direct or indirect. For example, the package may be associated with an indicium by printing, gluing, stapling, stitching, laminating, or otherwise directly, physically joining the indicium to the package. The indicium may be indirectly, physically associated with the package. For example, the indicium may reside on a hang-tag or removable sticker disposed on the package. The indicium may be intangibly associated with the package. For example, the indicium may be connected to the package electronically, as by an RFID tag, internet address, bar code, mobile tag, “QR” code (“Quick Response” code, often used with smartphones and other mobile computing devices), or the like. However, in this context, an “association” cannot be purely mental or imaginary. For example, a package comprising words which might cause a consumer to imagine, in her own mind, a mature human being is not “associated” with an image of a mature human being by virtue of the words. The image of the human may be as described above in terms of characteristics, possible associated activities, and styles and forms.

The indicium may comprise an image of an animal in the life stage for which the diet inside the package is nutritionally tailored. The image may depict the human interacting with the animal in a manner associated with (or appropriate for) the life stage of the animal for which the diet inside the package is nutritionally tailored. Exemplary activities and animal characteristics are described above. The human and/or animal image may vary in style and form, as described above.

Various disclosures and embodiments have been described with regard to an animal diet. The animal diet may be a complete and nutritionally balanced food source for an animal. In some embodiments, the disclosures related to an animal diet may be applicable to other forms of animal feed, including, without limitation, supplements, treats, gravies or flavorants comprising nutrients, and the like. In addition to a nutrient, an array of diets as described herein may further comprise varied levels of palatants or flavorants as a means to drive varied voluntary intake levels, as an addition lever for delivering varied nutrient intake.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An array of animal diets, the array comprising:
a first diet comprising a first level of a nutrient suitable for a first animal life stage, the first diet disposed in a first package;
a second diet comprising a second level of the nutrient suitable for a second animal life stage, the second diet disposed in a second package; and
a third diet comprising a third level of the nutrient suitable for a third animal life stage, the third diet disposed in a third package;
wherein each of the first, second, and third packages comprises an indicium, and the indicium of the first package comprises an image of a human being in a life stage comparable to the first animal life stage, the indicium of the second package comprises an image of a human being in a life stage comparable to the second animal life stage, and the indicium of the third package comprises an image of a human being in a life stage comparable to the third animal life stage.

2. The array of claim 1, wherein the indicia are selected from the group consisting of icons, drawings, and photographs.

3. The array of claim 1, wherein the indicium of the first package comprises the human being and an animal engaged in an activity characteristic of the first animal life stage.

4. The array of claim 1, wherein the nutrient is selected from the group consisting of 1-carnitine, low- or moderately-fermentable fiber, total fiber content, total protein content, vitamin E, other antioxidants, vitamin A, beta-carotene, lutein, taurine, fatty acids, the ratio of omega-6 to omega-3 fatty acids, glucosamine, chondroitin sulphate, DHA, EPA, caloric density, calcium, phosphorous, magnesium, lysine, sodium hexametaphosphates, a calorie restriction mimetic, a probiotic, a prebiotic, low glycemic index starches, high glycemic index starches, and combinations thereof.

5. The array of claim 1, wherein the nutrient is selected from the group consisting of 1-carnitine, low- or moderately-fermentable fiber, total fiber content, total protein content, vitamin E, other antioxidants, vitamin A, beta-carotene, lutein, taurine, fatty acids, the ratio of omega-6 to omega-3 fatty acids, glucosamine, chondroitin sulphate, DHA, EPA, caloric density, calcium, phosphorous, magnesium, lysine, sodium hexametaphosphates, a calorie restriction mimetic, a probiotic, a prebiotic, low glycemic index starches, high glycemic index starches, sodium bisulfate, and combinations thereof.

6. The array of claim 1, wherein each of the first, second, and third diets comprise a second nutrient at a first, second, and third level, respectively.

7. The array of claim 6, wherein each of the first, second, and third diets comprise a third nutrient at a first, second, and third level, respectively.

8. The array of claim 1, further comprising a fourth diet comprising a fourth level of the nutrient suitable for a fourth animal life stage, the fourth diet disposed in a fourth package, the fourth package comprising an indicium, the indicium comprising an image of a human being in a life stage comparable to the fourth animal stage of life.

9. The array of claim 8, wherein at least one of the first, second, third, and fourth levels of the nutrient is zero.

10. The array of claim 8, wherein each of the first, second, third, and fourth diets comprise a second nutrient at a first, second, third, and fourth level, respectively.

11. The array of claim 10, wherein each of the first, second, third, and fourth diets comprise a third nutrient at a first, second, third, and fourth level, respectively.

12. The array of claim 1, wherein the human being of the indicium of the first package, the indicium of the second package, and the indicium of the third package, is the same human being.

13. A method for facilitating the selection of a life-stage appropriate diet for an animal, the method comprising:
providing an array of diets for an animal, the diets nutritionally tailored to at least three life stages of the animal, each of the diets disposed in a package; and
associating each package with an indicium comprising an image of a human being in a life stage comparable to the life stage of the animal for which the diet inside the package is nutritionally tailored.

14. The method of claim 13, wherein the indicia further comprise an image of an animal in a life stage comparable to the life stage of the animal for which the diet inside the package is nutritionally tailored.

15. The method of claim 14, wherein the indicia further comprise an image of the human being interacting with the animal in a manner characteristic of the life stage of the animal for which the diet inside the package is nutritionally tailored.

16. The method of claim 13, wherein the array comprises at least four distinct diets.

17. The method of claim 16, wherein the array comprises at least six distinct diets.

18. The method of claim 13, wherein the animal is a dog or a cat.

19. The method of claim 13, wherein the human being of each indicium is the same human being.

20. The method of claim 14, wherein the animal of each indicium is the same animal.
